(19) United States
(12) Patent Application Publication
(10) Pub. No.: US 2015/0028675 A1
(43) Pub. Date: Jan. 29, 2015

(54) ELECTRICAL POWER SYSTEM AND METHOD FOR OPERATING AN ELECTRICAL POWER SYSTEM

(71) Applicants: Michael Scheurlen, Orlando, FL (US); James H. Sharp, Orlando, FL (US); Monica B. Hansel, Melbourne, FL (US); Michael S. Briesch, Orlando, FL (US)

(72) Inventors: Michael Scheurlen, Orlando, FL (US); James H. Sharp, Orlando, FL (US); Monica B. Hansel, Melbourne, FL (US); Michael S. Briesch, Orlando, FL (US)

(21) Appl. No.: 13/952,896

(22) Filed: Jul. 29, 2013

(51) Int. Cl. H02J 15/00; H02J 4/00

(52) U.S. Cl. CPC H02J 15/00; H02J 4/00
USPC 307/46; 307/44; 307/45

(57) ABSTRACT

An electrical power system includes a power grid and a plurality of power plants connected to the power grid. A central repository including one or more electrical energy storage devices is connected directly to the power grid. The one or more energy storage devices are configured to be connected to the power plants via the power grid. The central repository is operable to draw a portion of a power output produced by one or more of the power plants via the power grid during a first period, for storage therein. The central repository is operable to discharge power to the power grid during a second period shifted in time from the first period. The discharged power is a function of a grid requirement or a function of a power demand notified by an individual power plant of the electrical system.

### FIELD OF INVENTION

The present invention relates to an electrical power system, particularly to a system and method for power storage in relation to grid connected power plants.

### BACKGROUND OF INVENTION

An electrical power system typically includes one or more power plants supplying power to a grid. The power plants may include, for example, conventional fossil-fired power plants such as gas or steam turbine power plants, and/or renewable power plants such as wind turbines, photovoltaic cells, and concentrated solar plants, among others. The grid transmits power to a utility via a distribution network.

In operation of the electrical power system, there may be situations when the individual and/or collective power output of the power plants is not enough to meet the utility power demand, or that one (or multiple) of the power plants needs to be shut down, for e.g., repair, servicing, maintenance or any other reason. For example, certain power plants, referred to as peaker plants or peaker units, are run only during high-demand hours, and are shut down when the utility demand subsides, for example, at night.

When an individual power plant shuts down, i.e., stops producing power, there may still be tasks that require power. Examples of power requirement for conventional fossil-fired plants after shut down include providing power for turning gear, lube oil pumps, condenser fans, electric super heaters, instrument air compressors, plant operations consoles and computers, lights, air conditioners, etc. In the instance of a concentrated solar plant using molten salt or thermal oil, the same examples apply but there are even more serious power draws needed for pumps to keep the molten salt or oil moving or heaters needed to keep the molten salt at a temperature above its freezing point.

When a grid connected power plant shuts down, it normally uses either a dedicated emergency generator or a back feed from the grid in order to provide power for normal day to day operations or for restarting the plant. Most plants choose to use the back feed option and thus must purchase the needed power from the grid. This situation is true for conventional simple cycle and combined cycle plants as well as renewable energy plants such as concentrated solar power plants, wind turbines, photovoltaic cells, etc. For plants that shut down daily, for example in peaker plants, and concentrated solar plants, the cost of purchasing this power can be significant.

### SUMMARY OF INVENTION

An object of the present invention is to provide an improved and cost-effective mechanism for providing back feed power to grid connected plants.

Another object of the present invention is to provide an improved means for managing the power available at the grid in line with a grid requirement.

These and other objects are addressed by the features of the independent claims. Further features concerning specific embodiments are set forth in the dependent claims.

An underlying feature herein is to provide a central repository which is connected directly to the grid. The central repository may comprise a repository of rechargeable batteries or other energy storage devices. The idea is to connect the energy storage devices centrally and directly to the grid and not having them as dedicated storage devices for individual power plants. The central repository is operable to draw power from the grid and discharge or supply power to the grid. The individual power plants, while not directly connected to the central repository, may be in electrical connection with the central repository via the grid. This enables a centralized control of the power transaction between the central repository and the individual power plants. During a first period, the central repository may be operated in a charge mode, wherein portion of a power output produced by one or more of the power plants may be routed to the central repository via the power grid, whereby electrical energy is stored in the energy storage devices. During a second period, the central repository may be operated in a discharge mode, to supply power to the power grid. The second period is shifted in time from the first period. The time shift provides that the power discharged from the central repository may be controlled, for example by a centralized control system, as a function of a grid requirement or a function of a power demand notified by an individual power plant of the electrical system.

Thus, rather than purchasing power from the grid, an individual plant can generate the power it needs for offline operations while it is in normal daily or nightly operations, and store it in the central repository for its own later use. Since many plants do not normally run at 100% capacity, they should have enough additional capacity to divert a small amount each hour towards the storage. Additionally, through the grid, any number of facilities can be hooked into and later use the same central repository thus sharing the cost of the creation and maintenance of the facility as well as the costs associated with recharging the storage devices. In addition to the technical benefits, it has been determined that in case of multiple grid connected power plants, the shared cost of creation and maintenance of the central repository is significantly less than the cost of purchasing power from the grid or maintaining dedicated emergency generators by the individual power plants. The larger the number of participating power plants, the greater would be the cost benefit.

In one embodiment, the first period corresponds to an off-peak demand at the utility side. During such a time, most plants would run much below their full capacity, whereby a surplus amount of power can be conveniently diverted towards storage. Advantageously, in a further embodiment, the second period may correspond to a peak demand at the utility side. An energy arbitrage or load shifting is thereby achieved by discharging the energy storage devices during peak demand hours and charging the energy storage devices during off-peak periods.

In one embodiment, the second period corresponds to a shut-down of the individual power plant, wherein the power discharged from the central repository is used to back feed the individual power plant after its shut-down, for example for the type of offline operations as mentioned above.

In one embodiment, the power discharged from the central repository may be utilized to provide electrical preheating during the start-up of the individual power plant. This would provide a faster ramp rate at plant start up.

In one embodiment, during a shut-down of multiple power plants of the electrical power system, the power discharged from the central repository is utilized to start one of the power plants, which is then used to provide power to start-up a further power plant of the electrical power system.

In one embodiment, when the second period corresponds to a peak power demand, the central repository may be operated to discharge power to the power grid during the peak-demand period without operating additional peaker units during said peak-demand period. A deferment of new peaking capacity of the electrical power system is thereby achieved. This is particularly advantageous for small peaking needs and reduces the amount of emissions from peaker units.

In one embodiment, the central repository may be operated to discharge power to meet an intermittent or temporally changing grid demand requirement. In particular, load following/regulation may be achieved by providing small amounts of power for immediate grid demand requirements that might change, for example, every few minutes

In one embodiment, to achieve voltage/transmission support, the central repository may be operated to discharge power so as to stabilize a grid voltage level.

In one embodiment, the plurality of power plants includes at least one renewable energy plant, which may include, for example, a wind power plant, or a photovoltaic cell, or a concentrated solar power plant, or any combinations thereof. Renewable energy plants produce power from renewable sources such as wind, sun, etc, which are often intermittent in nature. The proposed storage system helps smooth out the grid when there is a sudden decrease in resources such as wind or sun. It is also particularly true for renewable energy sources that the peak power production period is not in line with the peak demand period. An energy arbitrage is therefore particularly advantageously achieved in case of renewable power plants by means of the proposed technique.

In one embodiment, the one or more electrical energy storage devices comprise rechargeable batteries. The rechargeable batteries may include one or more of the following, namely: sodium sulfur batteries, vanadium redox batteries, sodium nickel flow batteries, iron chrome batteries, lithium ion batteries, zinc bromide batteries, advanced lead acid batteries, or any combinations thereof. The above list is, however, non-limiting, and any other type of rechargeable battery may, in principle, be used for the purpose.

Alternately or additionally, the one or more electrical energy storage devices may comprise a flywheel energy storage system, or a pumped hydro system, or a compressed air energy storage system, or a superconducting magnetic energy storage system, or super-capacitors, or ultra-capacitors, or double layer capacitors, or any combinations thereof.

In one embodiment, the central repository comprising rechargeable batteries may be installed downstream of heavily congested transmission lines. Advantageously, such an installation avoids congestion related charges.

### BRIEF DESCRIPTION OF THE DRAWINGS

Embodiments of the present invention are illustrated in more detail by help of figures. The figures show example configurations and are not meant to be construed as limiting.

FIG. 1 is a schematic diagram illustrating an electrical power system having a central repository according to one embodiment,

FIG. 2 is an exemplary flowchart illustrating a charging of the central repository according to one embodiment,

FIG. 3 is an exemplary flowchart illustrating a discharging of the central repository according to a first embodiment,

FIG. 4 is an exemplary flowchart illustrating a discharging of the central repository according to a second embodiment, and

FIG. 5 is an exemplary graph illustrating the use of the central repository to bridge a power gap during a hot start.

### DETAILED DESCRIPTION OF INVENTION

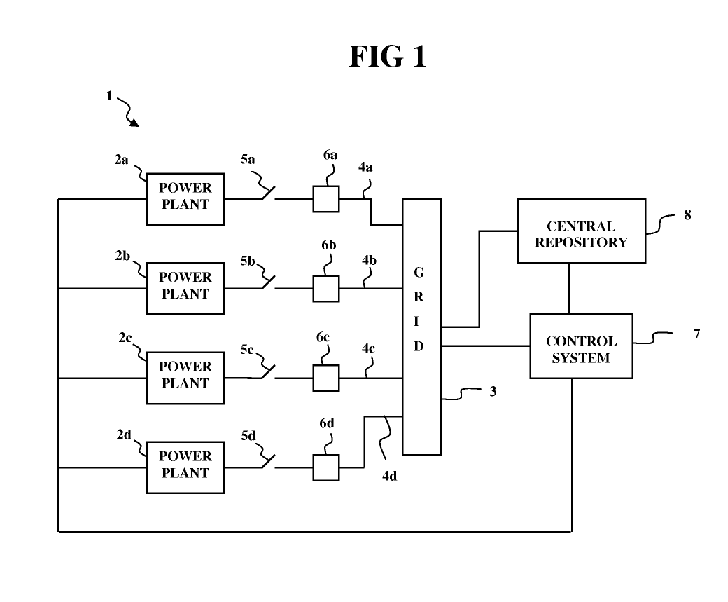

Turning now to FIG. 1, an electrical power system 1 is illustrated, which includes multiple power plants 2a, 2b, 2c, 2d. These may include, for example, conventional fossil-fired plants such as single and combined cycle plants. In the illustrated embodiment, at least one of the power plants 2a, 2b, 2c, 2d is a renewable power plant, particularly a wind power plant, or a concentrated solar plant, or a photovoltaic cell, or combinations thereof. The power plants 2a, 2b, 2c, 2d are connected to a power grid 3, via respective transmission lines 4a, 4b, 4c, 4d. The grid 3 transmits power to a utility via a distribution network (not shown). Each transmission line 4a, 4b, 4c, 4d includes typical transmission side components, including but not limited to, respective circuit breakers 5a, 5b, 5c, 5d and plant side transformers 6a, 6b, 6c, 6d. The transmission lines may also include one or more high voltage transformers to step up the voltage for the purpose of transmitting power over a long distance.

The power plants 2a, 2b, 2c, 2d may be located in regions having easy access to a fuel source or a renewable energy source. In a preferred embodiment, the power plants 2a, 2b, 2c, 2d are co-located in the same region. However, the present invention is not limited by such a requirement.

The electrical power system 1 includes a central repository 8 comprising one or more electrical energy storage devices. The central repository 8 is directly connected to the grid 3 and is operable to draw power directly from the grid 3 and likewise discharge power directly into the grid 3. Electrical connection between the central repository 8 and the individual power plants 2a, 2b, 2c, 2d is possible via the grid 3. In the illustrated embodiment, a centralized control system 7 is provided, which is connected to the grid and controls the charging and discharging of the central repository 8. The control system 7 may be operated in an automated manner, or manually by a grid operator.

In the illustrated embodiment, the electrical energy storage devices include rechargeable batteries. Examples include, but are not limited to, sodium sulfur batteries, or vanadium redox batteries, or sodium nickel flow batteries, or iron chrome batteries, or lithium ion batteries, zinc bromide batteries, or advanced lead acid batteries. A combination of any of the above is also possible.

Alternately or additionally, the electrical energy storage devices may also include one or more of the following, namely: a flywheel energy storage system, or a pumped hydro system, or a compressed air energy storage system, or a superconducting magnetic energy storage system, or super-capacitors, or ultra-capacitors, or double layer capacitors. All of the above have unique advantages, which may be utilized as appropriate to the power requirement from these devices. For example, flywheels are useful for fast response frequency regulation for short durations. Pumped hydro systems are highly effective with huge energy and power capacity and are particularly suitable for achieving energy arbitrage and some frequency regulation. Compressed air energy storage systems include compressors that fill a large cavern or container with air during off peak hours, which is used to power a wind turbine during peak hours. Thus, these systems are also advantageous for providing energy arbitrage and some frequency regulation. Superconducting magnetic energy storage systems are advantageous in that energy can be stored indefinitely and will not degrade as long as constant refrigeration is provided. Capacitors can be charged/discharged an unlimited number of times and can be charged very quickly to high power states.

The central repository 8 makes it possible for a portion of the power output produced during a first period to be utilized during a second period shifted in time from the first period. In particular, the proposed system allows the individual power plants 2a, 2b, 2c, 2d to utilize the power produced by them during their production hours, for their own later use, for example when they are offline or shut down or at the time or start up. This obviates the need to purchase power from the grid or to have dedicated emergency generators, all of which are relatively expensive options. The proposed system also potentially replaces all onsite or substation batteries, which would otherwise be used as emergency reserves, with a centralized back up system in the form of the central repository 8.

Since many plants do not normally run at 100% capacity, they should have enough additional capacity to divert a small amount each hour towards the storage. Accordingly, the charging operation of the central repository 8 may be scheduled during most operational hours of the individual power plants 2a, 2b, 2c, 2d. Advantageously, the first period (i.e., charging) falls within an off-peak demand period in relation to the grid 3.

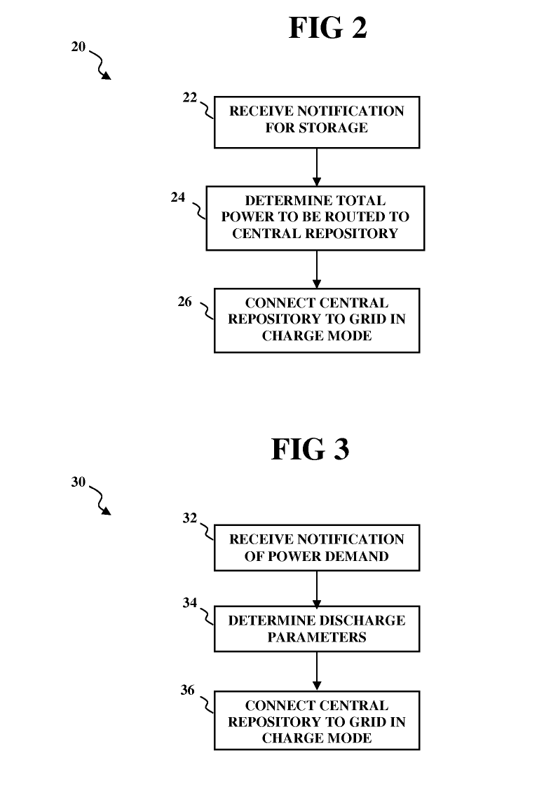

FIG. 2 is a flowchart illustrating an exemplary control method 20 of the charging of the central repository 8 according to an embodiment. At step 22, the control system 7 receives a notification during a first period from one or more of the power plants 2a, 2b, 2c, 2d that a power storage is intended by the individual power plant 2a, or 2b, or 2c, or 2d for a surplus amount of power to be produced over and above the individual/grid requirement. The notification may be sent by an operator of the individual plant 2a, 2b, 2c, 2d, or may be scheduled to be automated. At step 24, based on the notification, the control system 7 determines the total amount of power that needs to be diverted to the central repository 8 via the grid 3. This may, for example, be specified in the notification sent by the individual power plant 2a, or 2b, or 2c, or 2d, or otherwise determined from the surplus power detected from the grid 3. In case of multiple of the power plants 2a, 2b, 2c, 2d requesting energy storage at the same time, the control system 7 determines the total power to be diverted for storage in the central repository 8 on the basis of all the individual notifications (for example by adding the surplus power from each individual power plant). At step 26, the control system 7 operates to connect the central repository 8 to the grid 3 in a power charging mode, whereby the central repository 8 draws the exact or nearly exact amount of power (as determined in step 24) from the grid 3, to charge one or more of the storage devices in a controlled manner.

FIG. 3 is a flowchart illustrating an exemplary control method 30 for discharging power from the central repository 8 in accordance with a first embodiment. At step 32, the control system 7 receives a notification during a second period from an individual power plant 2a, or 2b, or 2c, or 2d which specifies a power demand by the individual power plant 2a, or 2b, or 2c, or 2d. This notification may be sent, for example, by an operator of the individual power plant 2a, or 2b, or 2c, or 2d when it goes offline or is shut down or requires power during a start up. At step 34, in response to the notification, the control system 7 determines discharge parameters, such as the exact amount of energy to be discharged from the central repository 8 and the rate of energy discharge (power). This may, for example, be specified in the notification. At step 36, the control system 7 operates to bring the repository 8 online, whereby the central repository 8 discharges the exact or nearly exact amount of power and energy (as determined in step 34) to the grid 3, which is then available to the requesting power plant 2a, or 2b, or 2c, or 2d via the grid 3.

In one example, the power discharged from the central repository is used to back feed the individual power plant after its shut-down. The back feed may be used, for example, for providing power for turning gear, lube oil pumps, condenser fans, electric super heaters, instrument air compressors, plant operations consoles and computers, lights, air conditioners, etc. In the instance of a concentrated solar plant using molten salt or thermal oil, the back feed may be further used in pumps to keep the molten salt or oil moving or heaters needed to keep the molten salt at a temperature above its freezing point.

During a shut-down of multiple power plants of the electrical power system, the power discharged from the central repository is utilized to start one of the power plants, which is then used to provide power to start-up a further power plant of the electrical power system.

In another example, the power discharged from the central repository may utilized during start up of the individual power plant to provide electrical preheating during said start-up of the individual power plant, to ensure a faster ramp rate at plant start up.

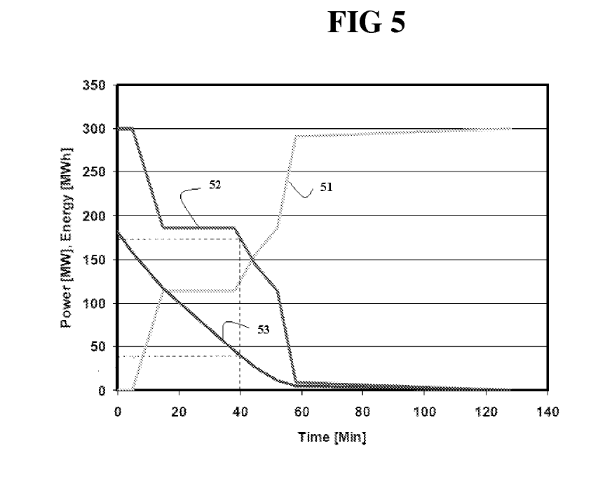

In yet another example, the power discharged from the central repository may utilized to bridge the power gap during a hot start of an individual power plant. This is illustrated referring to FIG. 5 which shows the use of a rechargeable battery to aid the hot start of a 300 MW power plant. In FIG, the X-axis represents time [min], while the Y-axis represents power [MW] and energy [MWh]. The curve 51 represents the plant load, the curve 52 represents the battery power, while the curve 53 represents battery energy. In this example, if battery is turned on after 40 min, it needs to deliver a maximum power of 175 MW and 40 MWh until the plant is at base load.

In all the above examples, the charging and the discharging of the central repository 8 is controlled based on an exact determination of power surplus and power requirement by the individual power plant(s) 2a, 2b, 2c, 2d, as illustrated in FIG. 2-3, such that no net power fluctuation is perceived at the grid 3 by way of the charging and discharging. In practice, the central control system 7 may maintain an individual energy account of each of the power plants 2a, 2b, 2c, 2d, in which records of all energy transactions between the respective power plant 2a, or 2b, or 2c, or 2d and the central repository 8 is maintained.

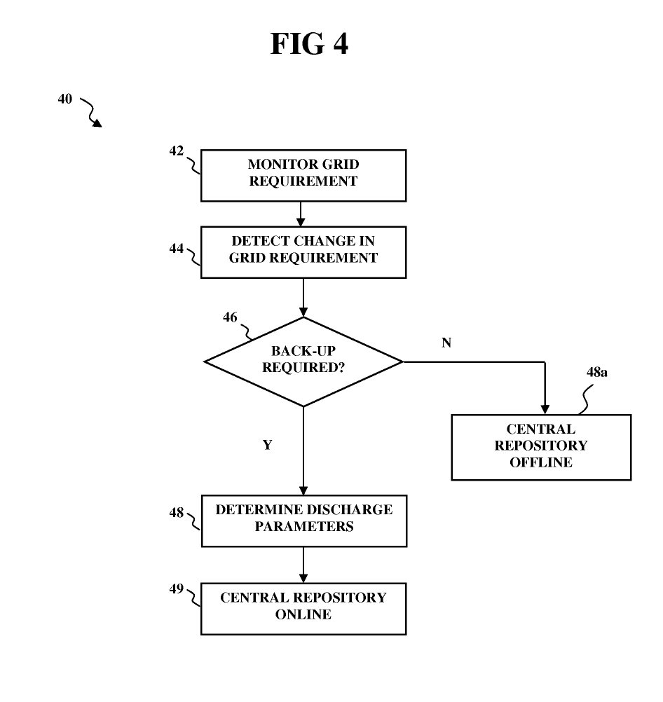

FIG. 4 is a flow chart illustrating a control method 40 for discharging the central repository 8 according to a second embodiment. The method may be implemented by the control system 7. The method 40 involves continuously monitoring a grid requirement (step 42), which may, for example be, in terms of power and/or voltage, among other parameters. At step 44, a change in grid requirement or a new grid requirement or peak demand is detected. At step 46, determination is made as to whether the central repository 8 is required to be brought online (in discharge mode). If so, at step 48, a determination is made on the discharge parameters of the central repository 8, for example, in terms of voltage and/or power. At step 49, the central repository 8 is brought online to discharge power to the grid 3 in a controlled manner on the basis of the determined discharge parameters. The central repository 8 may be subsequently taken offline (step 48a) if the grid requirement changes.

The above method allows load following/regulation to be achieved by providing small amounts of power for immediate grid demand requirements that might change, for example, every few minutes.

The above method also achieves voltage/transmission support, by operating the central repository to be operated to discharge power so as to stabilize a grid voltage level.

In one embodiment, when a peaking need is detected at the grid, the central repository may be operated to discharge power to the power grid during the peak-demand period without operating additional peaker units. A deferment of new peaking capacity of the electrical power system is thereby achieved. This is particularly advantageous for small peaking needs

While specific embodiments and dimensions have been described in detail, those with ordinary skill in the art will appreciate that various modifications and alternative to those details could be developed in light of the overall teachings of the disclosure. Accordingly, the particular arrangements disclosed are meant to be illustrative only and not limiting as to the scope of the invention, which is to be given the full breadth of the appended claims, and any and all equivalents thereof.

1. An electrical power system, comprising:
a power grid,
a plurality of power plants connected to the power grid,
a central repository comprising one or more electrical energy storage devices connected directly to the power grid, the one or more electrical energy storage devices being configured to be connected to the power plants via the power grid,
wherein the central repository is operable to be charged by drawing a portion of a power output produced by one or more of the power plants via the power grid during a first period, for storage therein, and
wherein the central repository is operable to be discharged by supplying power to the power grid during a second period shifted in time from the first period, wherein the discharged power is a function of a grid requirement or a function of a power demand notified by an individual power plant of the electrical system.

2. The electrical power system according to claim 1, wherein the first period corresponds to an off-peak power demand and the second period corresponds to a peak power demand.

3. The electrical power system according to claim 1, wherein the one or more electrical energy storage devices comprise rechargeable batteries.

4. The electrical power system according to claim 3, wherein the rechargeable batteries comprise one or more sodium sulfur batteries, or vanadium redox batteries, or sodium nickel flow batteries, or iron chrome batteries, or lithium ion batteries, zinc bromide batteries, or advanced lead acid batteries, or combinations thereof.

5. The electrical power system according to claim 1, wherein the one or more electrical energy storage devices comprises a flywheel energy storage system, or a pumped hydro system, or a compressed air energy storage system, or a superconducting magnetic energy storage system, or super-capacitors, or ultra-capacitors, or double layer capacitors, or any combinations thereof.

6. The electrical power system according to claim 1, wherein the plurality of power plants includes at least one renewable energy plant.

7. The electrical power system according to claim 6, wherein the at least one renewable energy plant includes a wind power plant, or a photovoltaic cell, or a concentrated solar power plant, or any combinations thereof.

8. The electrical power system according to claim 1, further comprising a centralized control system for determining the grid requirement or power requirements of individual power plants, and for controlling the charging and discharging of the central repository on the basis thereof.

9. A method for operating an electrical power system having a plurality of power plants connected to a power grid, the method comprising:
connecting a central repository comprising one or more electrical energy storage devices directly to the power grid, the central repository being operable to draw power from and discharging power to the power grid, the central repository being configured to be coupled to the power plants via the power grid,
routing a portion of a power output produced by one or more of the power plants for storage at the central repository via the power grid, during a first period,
receiving a power demand notification from an individual power plant of the electrical power system during a second period,
responsive to the notification, operating the central repository to discharge power as a function of said power demand, and making it available to the individual power plant via the power grid during the second period, the second period being shifted in time from the first period.

10. The method according to claim 9, wherein the first period corresponds to an off-peak power demand.

11. The method according to claim 9, wherein the second period corresponds to a shut-down of the individual power plant, wherein the power discharged from the central repository is used to back feed the individual power plant after its shut-down.

12. The method according to claim 9, wherein the second period corresponds to a start-up of the individual power plant, wherein the power discharged from the central repository is utilized to provide electrical preheating during said start-up of the individual power plant.

13. The method according to claim 9, wherein during a shut-down of multiple power plants of the electrical power system, the power discharged from the central repository is utilized to start one of the power plants, which is then used to provide power to start-up a further power plant of the electrical power system.

14. A method for operating an electrical power system having a plurality of power plants connected to a power grid, the method comprising:
connecting a central repository comprising one or more electrical energy storage devices directly to the power grid, the central repository being operable to draw power from and discharging power to the power grid, the central repository being configured to be coupled to the power plants via the power grid,
routing a portion of a power output produced by one or more of the power plants for storage at the central repository via the power grid, during a first period, and
operating the central repository to discharge power to the power grid during a second period as a function of a grid requirement, the second period being shifted in time from the first period.

15. The method according to claim 14, wherein the second period corresponds to a peak power demand, wherein the central repository is operated to discharge power to the power grid during the peak power demand period without operating additional peaker units during said peak-demand period.

16. The method according to claim 14, comprising operating the central repository to discharge power to meet an intermittent or temporally changing grid demand requirement.

17. The method according to claim 14, comprising operating the central repository to discharge power so as to stabilize a grid voltage level.
